(19) United States
(12) Patent Application Publication
(10) Pub. No.: US 2025/0162804 A1
(43) Pub. Date: May 22, 2025

(54) A DELIVERY PORT FOR DELIVERY OF GOODS CONTAINED IN GOODS HOLDERS

(71) Applicant: Autostore Technology AS, Nedre Vats (NO)

(72) Inventor: Erik Strømme, Borgen (NO)

(73) Assignee: Autostore Technology AS, Nedre Vats (NO)

(21) Appl. No.: 18/698,297

(22) PCT Filed: Oct. 6, 2022
(86) PCT No.: PCT/EP2022/077758

§ 371 Date: Apr. 3, 2024

(30) Foreign Application Priority Data
Oct. 13, 2021 (NO) 20211238

(51) Int. Cl. B65G 1/06; B65G 1/04; B65G 1/137

(52) U.S. Cl. CPC B65G 1/065; B65G 1/0464; B65G 1/1373

(57) ABSTRACT

A delivery port is for delivery of goods contained in goods holders originating from a storage and retrieval system for storing goods holders. The delivery port includes a first path, a delivery vehicle for transporting goods holders, a second path, and a pair of conveyors. The delivery vehicle is movable on the first path. The goods holder is movable on the second path. The second path includes a delivery point where the goods holder is emptied of its content, such as product items. The pair of conveyors establish a dual connection between the first and the second path. The goods holder is transferable around a closed loop formed by the first and the second paths and the pair of conveyors. A mechanism is provided in said delivery point. The mechanism enables strictly vertical movement of the goods holder.

The present invention relates to a delivery port for delivery of goods contained in goods holders originating from a storage and retrieval system for storing goods holders.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

WO2019/238664 discloses an automated storage and retrieval system comprising a storage space and a delivery system for transporting storage containers. The delivery system comprises a container handling vehicle that travels between the storage space and a delivery station accessible by a human or robotic operator.

There is more than one path to/from the delivery station for the container handling vehicle.

Frequently, an automated storage and retrieval system of the kind described in conjunction with FIG. 1 is integrated with a retail establishment. In that case, customer delivery of purchased products may be assisted by the container handling vehicles of the system. More specifically, an automated storage and retrieval system of this kind typically comprises an area where products purchased by the customer are aggregated into storage containers of the system. Subsequently, these storage containers need to be delivered to the customer. In order to ensure a safe and secure hand-off, it is preferred for the product delivery to take place at a distance from the retail establishment and its automated storage and retrieval system.

In a related context, most customers prefer to pick-up purchased products close to the car, i.e. normally at a significant distance from the retail establishment. Conventionally, this customer wish is met by an employee aggregating all products of the customer order in storage containers, loading the storage containers on a trolley and manually transporting the trolley to the customer's car. This procedure is labor-intensive and time-consuming.

A part of this procedure is disclosed in US2015/378345A1. More specifically, it is disclosed a manner in which the employee may aggregate in a storage container the products making up the customer order.

In view of all of the above, it is desirable to provide a solution that solves or at least mitigates one or more of the aforementioned problems belonging to the prior art.

### SUMMARY OF THE INVENTION

The present invention is set forth and characterized in the independent claims, while the dependent claims describe other characteristics of the invention.

First aspect of the invention relates a delivery port for delivery of goods contained in goods holders originating from a storage and retrieval system for storing goods holders, said delivery port comprising:
a first path,
a delivery vehicle for transporting goods holders, said delivery vehicle being movable on the first path,
a second path, said goods holder being movable on the second path, said second path comprising a delivery point where the goods holder is emptied of its content, such as product items,
a pair of conveyors establishing a dual connection between the first and the second path,
said goods holder being transferable around a closed loop formed by the first and the second paths and the pair of conveyors, and
a mechanism being provided in said delivery point, said mechanism enabling strictly vertical movement of the goods holder.

By providing the delivery port as defined above, a completely stand-alone unit for delivery of purchased products is achieved. Accordingly, the delivery port may be employed with storage and retrieval systems having different designs and inherent properties. In addition and provided the vehicle and the paths are suitably equipped, the delivery port could become fully automated such that delivery process doesn't require attendance by an operator.

Moreover, the length of the first and the second paths is easily adjusted so that the product delivery can take place at a safe distance from the storage and retrieval system.

Also, in embodiments where motion of the vehicle is one dimensional, the overall complexity is significantly reduced compared to systems featuring vehicles moving in two directions. In a related context, in the embodiments where the delivery port comprises a single vehicle, risk of vehicle collisions is eliminated.

Second aspect of the invention relates to a method for delivery of goods contained in goods holders originating from a storage and retrieval system for storing goods holders, said method comprising following steps:
transferring said goods holder around a closed loop formed by a first and a second paths and a pair of conveyors, and
strictly vertically moving the goods holder in a delivery point where the goods holder is emptied of its content, such as product items.

For the sake of brevity, advantages discussed above in connection with the delivery port may even be associated with the corresponding method and are not further discussed. Here, it is to be construed that the sequence of method steps of the above claim may be effectuated in any given order.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system.

Analogously, the term “storage container” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4a is a schematic top view of a delivery port in accordance with one embodiment of the present invention.

FIG. 4b is a schematic top view of a delivery port in accordance with another embodiment of the present invention.

FIG. 4c is a schematic top view of a delivery port in accordance with yet another embodiment of the present invention.

FIG. 5 is a schematic side view of a delivery port with a delivery point in accordance with an embodiment of the present invention.

FIG. 6a is a side view of a delivery vehicle for use in a delivery port of the present invention.

FIG. 6b is a top view of the delivery vehicle shown in FIG. 6a.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

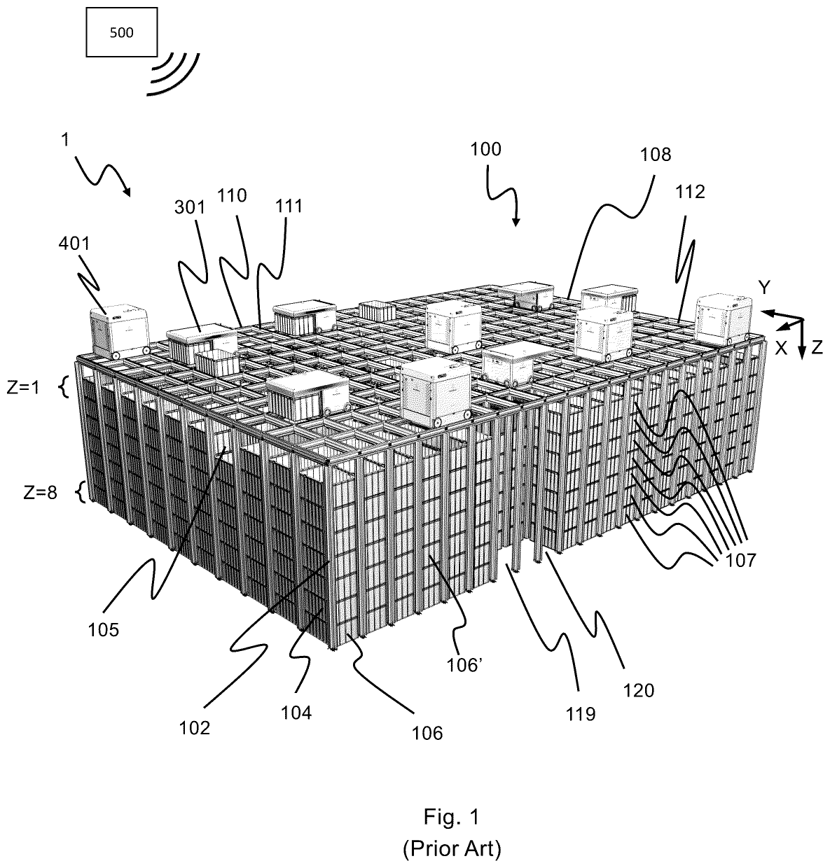

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

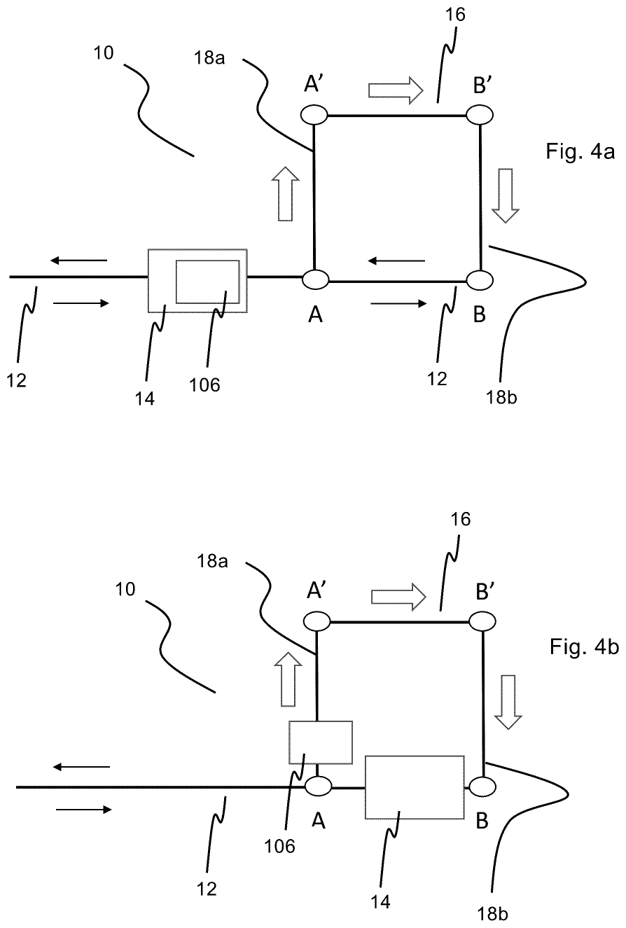

Various aspects of the present invention will now be discussed in more detail with reference to FIGS. 4a-6b.

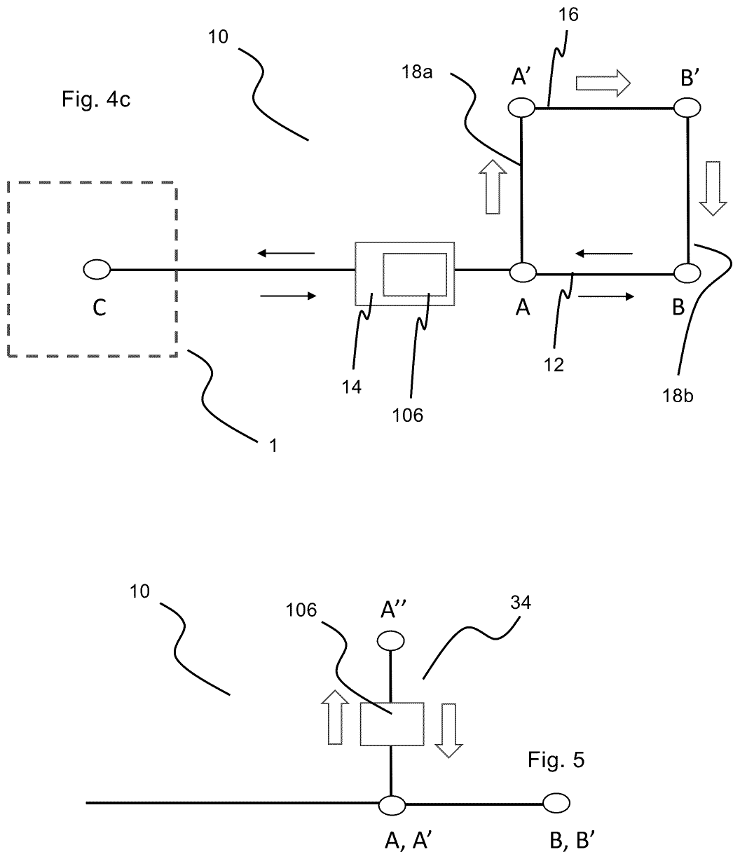

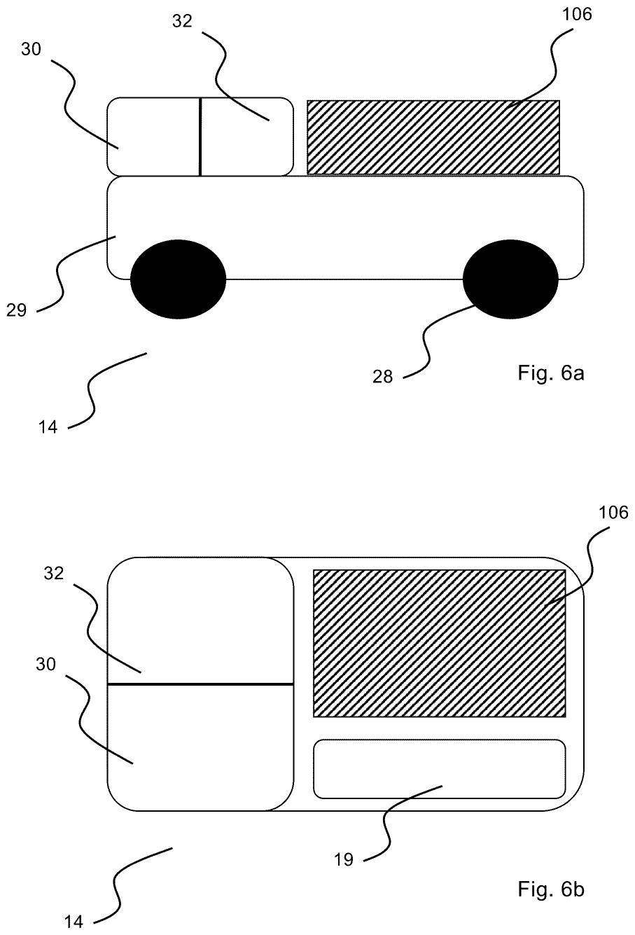

FIG. 4a is a schematic top view of a delivery port in accordance with one embodiment of the present invention. The shown delivery port 10 may be used for delivery of goods contained in goods holders 106 originating from a storage and retrieval system (1; shown in FIG. 1) for storing goods holders 106. With reference to FIG. 4a (but also FIGS. 4b-4c and FIG. 5), regular arrows denote movement of a delivery vehicle 14, either with or without the goods holder, whereas block arrows denote movement of the goods holder 106 when decoupled from the delivery vehicle 14. The delivery port 10 comprises a first path 12 and a delivery vehicle 14 for transporting goods holders 106, said delivery vehicle 14 being movable on the first path 12. In one embodiment, said first path 12 comprises a rail. The vehicle 14 is discussed in greater detail in connection with FIGS. 6a-6b.

The port 10 further comprises a second path 16, wherein the goods holder 106, when decoupled from the vehicle, is movable on the second path 16. The second path 16 comprises a delivery point (discussed greater detail in connection with FIG. 5) where the goods holder is emptied of its content, such as product items. It is further shown a pair of conveyors 18a, 18b establishing a dual connection between the first 12 and the second 16 path. Here, the term conveyor is to be construed broadly, i.e. as encompassing all devices/manners of conveying the goods holder 106 from the first 12 to the second 16 path. The goods holder 106 is transferable around a closed loop formed by the first 12 and the second 16 paths and the pair of conveyors 18a, 18b. The port further comprises a mechanism provided in said delivery point, said mechanism enabling strictly vertical movement of the goods holder 106.

By providing the delivery port 10, a completely stand-alone unit for delivery of purchased products is achieved. Accordingly, the delivery port may be employed with storage and retrieval systems (1; shown in FIG. 1) having different designs and inherent properties. In addition and provided the vehicle and the paths are suitably equipped, the delivery port could become fully automated such that delivery process doesn't require attendance by an operator. Moreover, the length of the first 12 and the second 16 paths is easily adjusted so that the product delivery can take place at a safe distance from said storage and retrieval system.

Still with reference to FIG. 4a, the delivery vehicle 14 is arranged to stop at least in positions A and B along the first path 12 and the goods holder 106 is arranged to stop in positions A′ and B′ along the second path 16. The goods holder 106 containing goods is, when the vehicle 14 is in position A of the first path 12, removed from the delivery vehicle 14 and, via conveyor 18a, transferred to a delivery point (mentioned in connection with FIG. 4a) of the second path (16), said delivery point comprising position A′ and position A″ vertically aligned with position A′. As more thoroughly discussed in connection with FIG. 5, the goods holder 106 is emptied of its content in said delivery point. The delivery vehicle 14 not carrying a goods holder subsequently advances to position B. The goods holder 106 is emptied of its content in position A′ and subsequently, via conveyor 18b, moved to position B′. The empty goods holder 106 is, in position B′ of the second path 16, transferred to position B of the first path 12 where said goods holder is accommodated by the waiting vehicle 14.

FIG. 4b is a schematic top view of a delivery port in accordance with another embodiment of the present invention. In FIG. 4b, the goods holder 106 containing goods is being transferred to position A′ whereas the vehicle 14 is on its way to position B. For the sake of brevity, the parts discussed above in connection with FIG. 4a are not further discussed in connection with FIG. 4b. Still with reference to FIG. 4b, a direction of extension of the first path 12 may be substantially parallel to a direction of extension of the second path 16. Moreover, a direction of movement of the goods holder 106 being removed from the vehicle 14 and transferred to position A′ of the second path 16 may be perpendicular to the direction of extension of the first path 12. Here, a first ejector (not shown) for removing the goods holder 106 from the vehicle 14 may be associated with the first path 12, typically in position A. As shown in FIG. 6b, the ejector may also be a part of the delivery vehicle. A direction of movement of the goods holder 106 being transferred to position B of the first path 12 is perpendicular to the direction of extension of the first path 12.

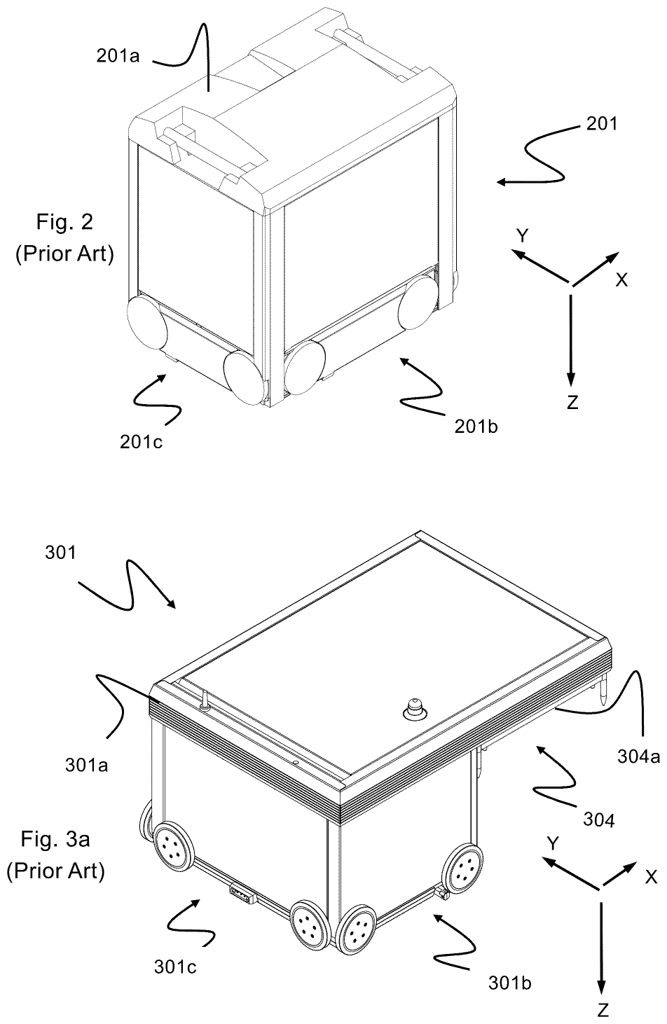

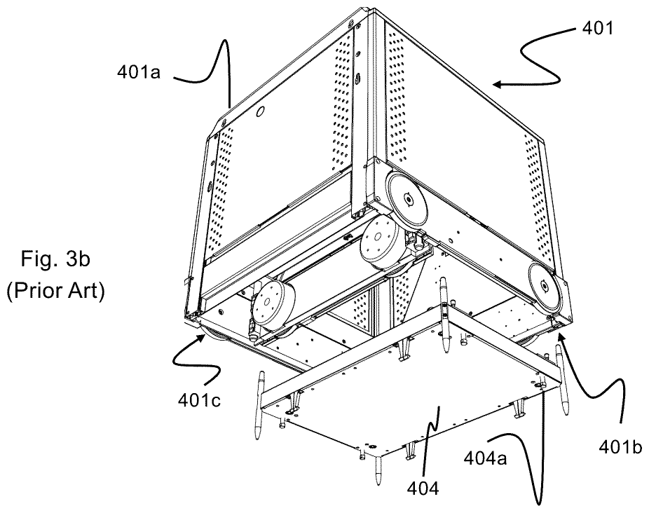

FIG. 4c is a schematic top view of a delivery port 10 in accordance with yet another embodiment of the present invention. For the sake of brevity, the parts discussed above in connection with FIGS. 4a-4b are not further discussed in connection with FIG. 4c. In FIG. 4c, the delivery vehicle 14 is further arranged to stop in position C along the first path 12. The position C is within the storage and retrieval system 1 (discussed in connection with FIG. 1) for storing goods holders 106. A remotely operated vehicle (shown in FIGS. 2-3b) operating on top of the storage and retrieval system 1 may in position C place goods holders 106 on the delivery vehicle 14 or remove goods holders 106 from the delivery vehicle 14. This is done in a manner well-known to the person skilled in the art. Hence, the remotely operated vehicle and the delivery vehicle 14 are both in position C, only at different levels.

Still with reference to FIG. 4c, the second path 16 may comprise active rollers for advancing the goods holder 106 between position A′ and position B′. Alternatively, the second path 16 could comprise a second ejector (not shown) and passive rollers for advancing the goods holder 106 between position A′ and position B′. The second ejector normally moves in a direction that is substantially parallel to the direction of extension of the second path 16. The goods holder 106 may be transferred from position B′ of the second path 16 to position B of the first path 12 by means of a third ejector (not shown). Said third ejector typically moves in a direction that is perpendicular to the direction of extension of the first path 12.

FIG. 5 is a schematic side view of a delivery port 10 with a delivery point 34 in accordance with an embodiment of the present invention. In the shown embodiment, a mechanism enabling vertical movement of the goods holder 106 is provided in the delivery point 34. Typically, the filled goods holder 106 is raised from position A′ to position A″ where it is emptied of its content by the waiting end consumer. The empty goods holder 106 is subsequently lowered back to position A′. This set-up is particularly useful when the first and second paths are provided underground. Also, the set-up confers greater customer safety as it becomes easier to shield the waiting customer from the arriving goods holder.

In one embodiment (not shown), said mechanism for lifting/lowering the filled/empty goods holder may be hydraulic-based, lever-based or rack-and-pinion-based. More specifically and with reference to FIG. 5, said mechanism is typically arranged below a support plate for receiving the goods holder in position A′. Mechanism acts on the support plate and the supported goods holder with product items such that they move upward and eventually reach position A″ where an end consumer collects the content of the goods holder. Once the goods holder in position A″ is empty, the mechanism acts on the support plate and the supported empty goods holder such that they move downward and eventually regain position A′.

In a further embodiment, the content of the goods holder 106 comprises a receptacle (not shown) enclosing the product items, i.e. an outer goods holder 106 surrounds an inner tote or a storage bin holding the product items. This inner receptacle with the product items may be extracted from the goods holder 106 by the end consumer and, by way of example, placed in the consumer's car.

In a preferred embodiment, the delivery port 10 comprises a single delivery vehicle 14 for goods holders. In a related embodiment, the motion of the delivery vehicle 14 is one dimensional, i.e. horizontal, and said delivery vehicle transports a single goods holder 106. Hereby, the overall port complexity is significantly reduced and, when the delivery port comprises a single vehicle, risk of vehicle collisions is eliminated.

FIG. 6a is a side view of a delivery vehicle 14 for use in a delivery port of the present invention. The vehicle 14 comprises wheels 28, a vehicle body 29, an easily accessible power-supplying battery 30 and a motor 32. A goods holder 106 supported by the vehicle body 29 is also shown.

FIG. 6b is a top view of the delivery vehicle 14 shown in FIG. 6a. A first ejector 19 being part of the delivery vehicle 14 is also shown. With reference to FIGS. 4-5, the goods holder 106 may be removed from the delivery vehicle 14 and transferred on the conveyor 18a (shown in FIGS. 4a-4c) by means of the first ejector 19.

In the preceding description, various aspects of the delivery port for delivery of goods contained in goods holders originating from a storage and retrieval system for storing goods holders according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Storage and retrieval system
10 Delivery port
12 First path
14 Delivery vehicle
16 Second path
18a, 18b Pair of conveyors
19 First ejector
28 Wheels
29 Body
30 Vehicle battery
32 Vehicle motor
34 Delivery point
100 Framework structure
102 Upright members of framework structure
104 Storage grid
105 Storage column
106 Storage container/goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
500 Control system
X First direction
Y Second direction
Z Third direction

1. A delivery port for delivery of goods contained in goods holders originating from a storage and retrieval system for storing goods holders, said delivery port comprising:
a first path,
a delivery vehicle for transporting goods holders, said delivery vehicle being movable on the first path,
a second path, said goods holder being movable on the second path, said second path comprising a delivery point where the goods holder is emptied of its content, such as product items,
a pair of conveyors establishing a dual connection between the first and the second path,
said goods holder being transferable around a closed loop formed by the first and the second paths and the pair of conveyors, and
a mechanism being provided in said delivery point, said mechanism enabling strictly vertical movement of the goods holder.

2. The delivery port of claim 1, wherein said delivery vehicle for transporting goods holders is arranged to stop at least in positions A and B along the first path, wherein said goods holder is arranged to stop in positions A′ and B′ along the second path, and wherein the goods holder containing goods is arranged to, when the vehicle is in position A of the first path, be removed from the delivery vehicle and transferred to said delivery point comprising position A′ of the second path and position A″ that is vertically aligned with position A′, the goods holder being emptied of its content in said delivery point, and wherein the empty goods holder is arranged to, in position B′ of the second path, be transferred to position B of the first path.

3. The delivery port of claim 2, wherein said delivery vehicle further is arranged to stop in position C along the first path, wherein position C is within the storage and retrieval system for storing goods holders and wherein a remotely operated vehicle operating on top of the storage and retrieval system may in position C place goods holders on the delivery vehicle or remove goods holders from the delivery vehicle.

4. The delivery port of claim 1, wherein a direction of extension of the first path is substantially parallel to a direction of extension of the second path.

5. The delivery port of claim 4, wherein a direction of movement of the goods holder being removed from the delivery vehicle and transferred to position A′ of the second path is perpendicular to the direction of extension of the first path.

6. The delivery port of claim 4, wherein a direction of movement of the goods holder being transferred to position B of the first path is perpendicular to the direction of extension of the first path.

7. The delivery port of claim 1, wherein the goods holder is removed from the delivery vehicle and transferred to position A′ of the second path by means of a first ejector.

8. The delivery port of claim 7, wherein the first ejector is part of the delivery vehicle.

9. The delivery port of claim 8, wherein the first ejector is associated with the first path.

10. The delivery port of claim 1, wherein the second path comprises active rollers for advancing the goods holder between position A′ and position B′.

11. The delivery port of claim 1, wherein the second path comprises a second ejector and passive rollers for advancing the goods holder between position A′ and position B′.

12. The delivery port of claim 11, wherein the second ejector moves in a direction that is substantially parallel to the direction of extension of the second path.

13. The delivery port of claim 1, wherein the goods holder is transferred from position B′ of the second path to position B of the first path by means of a third ejector.

14. The delivery port of claim 13, wherein the third ejector moves in a direction that is perpendicular to the direction of extension of the first path.

15. The delivery port of claim 1, wherein the delivery port comprises a single delivery vehicle for goods holders.

16. The delivery port of claim 1, wherein the delivery vehicle transports a single goods holder.

17. The delivery port of claim 1, wherein motion of the delivery vehicle is one dimensional.

18. The delivery port of claim 1, wherein said first path comprises a rail.

19. The delivery port of claim 1, wherein a ratio of the length of the second path and the length of the goods holder is in the range 2-6.

20. The delivery port of claim 1, wherein the first and second paths are provided underground and the strictly vertical movement is an upward movement followed by a downward movement.

21. The delivery port of claim 1, wherein the content of said goods holder originating from a storage and retrieval system for storing goods holders comprises a receptacle enclosing the product items.

22. The delivery port of claim 1, wherein the content of said goods holder originating from a storage and retrieval system for storing goods holders is delivered to an end consumer at the delivery point.

23. A method for delivery of goods contained in goods holders originating from a storage and retrieval system for storing goods holders, said method comprising:
transferring said goods holder around a closed loop formed by a first and a second paths and a pair of conveyors,
strictly vertically moving the goods holder in a delivery point where the goods holder is emptied of its content, such as product items.

24. The method of claim 23, said method comprising:
positioning a delivery vehicle transporting a goods holder containing goods in position A of the first path, said delivery vehicle being movable on the first path,
transferring said goods holder from position A to position A′ of a second path, said goods holder being movable on the second path,
in said delivery point, strictly vertically moving the goods holder from position A′ to position A″,
emptying said goods holder of its content in position A″,
in said delivery point, strictly vertically moving the emptied goods holder from position A″ to position A′,
advancing said delivery vehicle to position B from position A,
advancing said goods holder to position B′ from position A′,
transferring said goods holder from position B′ to position B to be accommodated by said vehicle.

25. The method of claim 24, said method comprising:
placing, by means of a remotely operated vehicle operating on top of the storage and retrieval system for storing goods holders, filled goods holders on the delivery vehicle or removing empty goods holders from the delivery vehicle in position C disposed within the storage and retrieval system.
